(19) United States
(12) Patent Application Publication
(10) Pub. No.: US 2009/0219253 A1
(43) Pub. Date: Sep. 3, 2009

(54) Interactive Surface Computer with Switchable Diffuser

(75) Inventors: Shahram Izadi, Cambridge (GB); Daniel A. Rosenfeld, Seattle, WA (US); Stephen E. Hodges, Cambridge (GB); Stuart Taylor, Cambridge (GB); David Alexander Butler, Cambridge (GB); Otmar Hilliges, Cambridge (GB); William Buxton, Toronto (CA)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/040,629

(22) Filed: Feb. 29, 2008

(51) Int. Cl. G06F 3/041

(52) U.S. Cl. 345/173

(57) ABSTRACT

An interactive surface computer with a switchable diffuser layer is described. The switchable layer has two states: a transparent state and a diffusing state. When it is in its diffusing state, a digital image is displayed and when the layer is in its transparent state, an image can be captured through the layer. In an embodiment, a projector is used to project the digital image onto the layer in its diffusing state and optical sensors are used for touch detection.

### BACKGROUND

Traditionally, user interaction with a computer has been by way of a keyboard and mouse. Tablet PCs have been developed which enable user input using a stylus and touch sensitive screens have also been produced to enable a user to interact more directly by touching the screen (e.g. to press a soft button). However, the use of a stylus or touch screen has generally been limited to detection of a single touch point at any one time.

Recently, surface computers have been developed which enable a user to interact directly with digital content displayed on the computer using multiple fingers. Such a multi-touch input on the display of a computer provides a user with an intuitive user interface, but detection of the multiple touch events is difficult. An approach to multi-touch detection is to use a camera either above or below the display surface and to use computer vision algorithms to process the captured images. Use of a camera above the display surface enables imaging of hands and other objects which are on the surface but it is difficult to distinguish between an object which is close to the surface and an object which is actually in contact with the surface. Additionally, occlusion can be a problem in such ‘top-down’ configurations. In the alternative ‘bottom-up’ configuration, the camera is located behind the display surface along with a projector which is used to project the images for display onto the display surface which comprises a diffuse surface material. Such ‘bottom-up’ systems can more easily detect touch events, but imaging of arbitrary objects is difficult.

The embodiments described below are not limited to implementations which solve any or all of the disadvantages of known surface computing devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An interactive surface computer with a switchable diffuser layer is described. The switchable layer has two states: a transparent state and a diffusing state. When it is in its diffusing state, a digital image is displayed and when the layer is in its transparent state, an image can be captured through the layer. In an embodiment, a projector is used to project the digital image onto the layer in its diffusing state and optical sensors are used for touch detection.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a surface computing device;

FIG. 2 is a flow diagram of an example method of operation of a surface computing device;

FIG. 3 is a schematic diagram of another surface computing device;

FIG. 4 is a flow diagram of another example method of operation of a surface computing device;

FIG. 5 shows two example binary representations of captured images;

FIGS. 6-8 show schematic diagrams of further surface computing devices;

FIG. 9 shows a schematic diagram of an array of infra-red sources and sensors;

FIGS. 10-14 show schematic diagrams of further surface computing devices;

FIG. 15 is a flow diagram showing a further example method of operation of a surface computing device; and

FIG. 16 is a schematic diagram of another surface computing device. Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

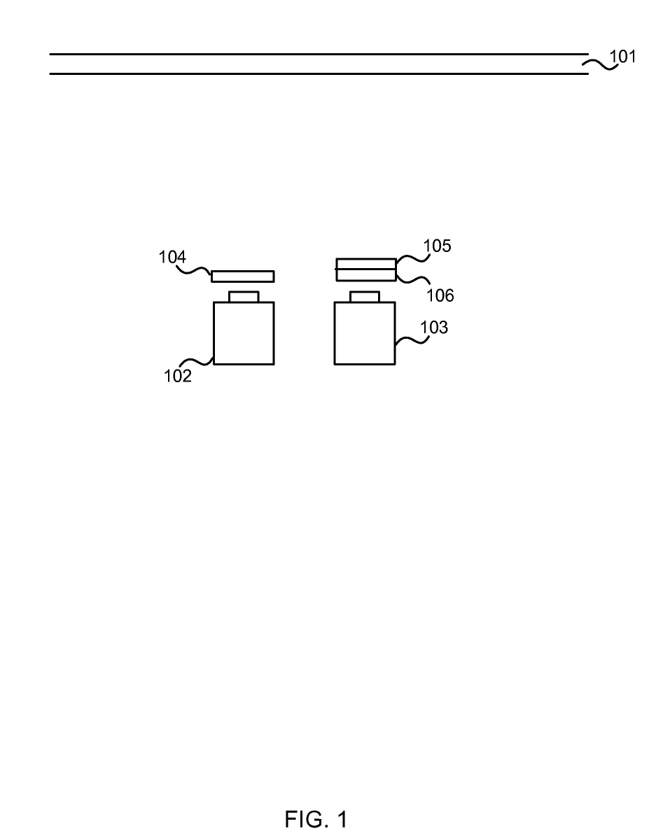

FIG. 1 is a schematic diagram of a surface computing device which comprises: a surface 101, which is switchable between a substantially diffuse state and a substantially transparent state; a display means, which in this example comprises a projector 102; and an image capture device 103, such as a camera or other optical sensor (or array of sensors). The surface may, for example, be embedded horizontally in a table. In the example shown in FIG. 1, the projector 102 and the image capture device 103 are both located below the surface. Other configurations are possible and a number of other configurations are described below.

The term ‘surface computing device’ is used herein to refer to a computing device which comprises a surface which is used both to display a graphical user interface and to detect input to the computing device. The surface may be planar or may be non-planar (e.g. curved or spherical) and may be rigid or flexible. The input to the computing device may, for example, be through a user touching the surface or through use of an object (e.g. object detection or stylus input). Any touch detection or object detection technique used may enable detection of single contact points or may enable multi-touch input.

The following description refers to a ‘diffuse state’ and a ‘transparent state’ and these refer to the surface being substantially diffusing and substantially transparent, with the diffusivity of the surface being substantially higher in the diffuse state than in the transparent state. It will be appreciated that in the transparent state the surface may not be totally transparent and in the diffuse state the surface may not be totally diffuse. Furthermore, as described above, in some examples, only an area of the surface may be switched (or may be switchable).

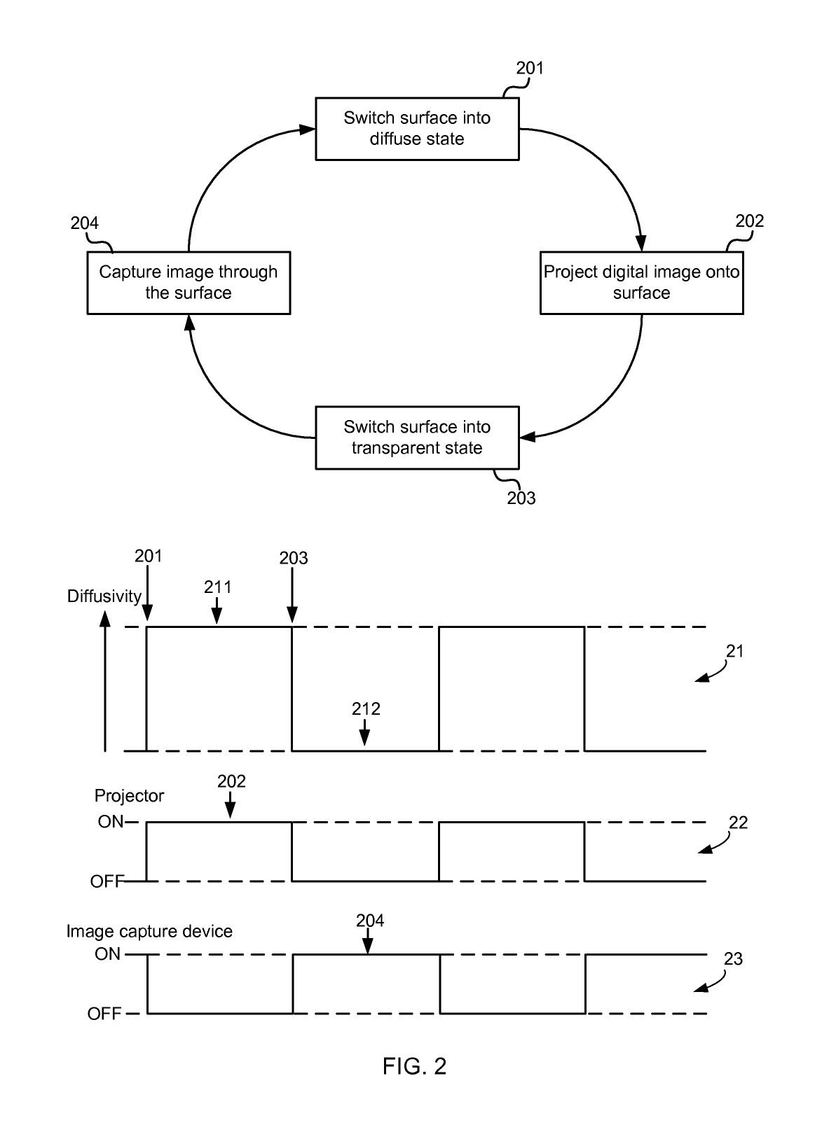

An example of the operation of the surface computing device can be described with reference to the flow diagram and timing diagrams 21-23 shown in FIG. 2. The timing diagrams 21 -23 show the operation of the switchable surface 101 (timing diagram 21), projector 102 (timing diagram 22) and image capture device (timing diagram 23) respectively. With the surface 101 in its diffuse state 211 (block 201), the projector 102 projects a digital image onto the surface (block 202). This digital image may comprise a graphical user interface (GUI) for the surface computing device or any other digital image. When the surface is switched into its transparent state 212 (block 203), an image can be captured through the surface by the image capture device (block 204). The captured image may be used for detection of objects, as described in more detail below. The process may be repeated.

The surface computing device as described herein has two modes: a ‘projection mode’ when the surface is in its diffuse state and an ‘image capture mode’ when the surface is in its transparent mode. If the surface 101 is switched between states at a rate which exceeds the threshold for flicker perception, anyone viewing the surface computing device will see a stable digital image projected on the surface.

A surface computing device with a switchable diffuser layer (e.g. surface 101), such as that shown in FIG.1, may provide the functionality of both a bottom-up configuration and a top-down configuration, such as providing the ability to distinguish touch events, supporting imaging in the visible spectrum and enabling imaging/sensing of objects at a greater distance from the surface. The objects which may be detected and/or imaged may include a user's hands or fingers or inanimate objects.

The surface 101 may comprise a sheet of Polymer Stabilised Cholesteric Textured (PSCT) liquid crystal and such a sheet may be electrically switched between diffuse and transparent states by applying a voltage. PSCT is capable of being switched at rates which exceed the threshold for flicker perception. In an example, the surface may be switched at around 120 Hz. In another example, the surface 101 may comprise a sheet of Polymer Dispersed Liquid Crystal (PDLC); however the switching speeds which can be achieved using PDLC are generally lower than with PSCT. Other examples of surfaces which can be switched between a diffuse and a transparent state include a gas filled cavity which can be selectively filled with a diffusing or transparent gas, and a mechanical device which can switch dispersive elements into and out of the plane of the surface (e.g. in a manner which is analogous to a Venetian blind). In all these examples, the surface can be electrically switched between a diffuse and a transparent state. Dependent upon the technology used to provide the surface, the surface 101 may have only two states or may have many more states, e.g. where the diffusivity can be controlled to provide many states of different amounts of diffusivity.

In some examples, the whole of the surface 101 may be switched between the substantially transparent and the substantially diffuse states. In other examples, only a portion of the screen may be switched between states. Depending on the granularity of control of the area which is switched, in some examples, a transparent window may be opened up in the surface (e.g. behind an object placed on the surface) whilst the remainder of the surface stays in its substantially diffuse state. Switching of portions of the surface may be useful where the switching speed of the surface is below the flicker threshold to enable an image or graphical user interface to be displayed on a portion of the surface whilst imaging occurs through a different portion of the surface.

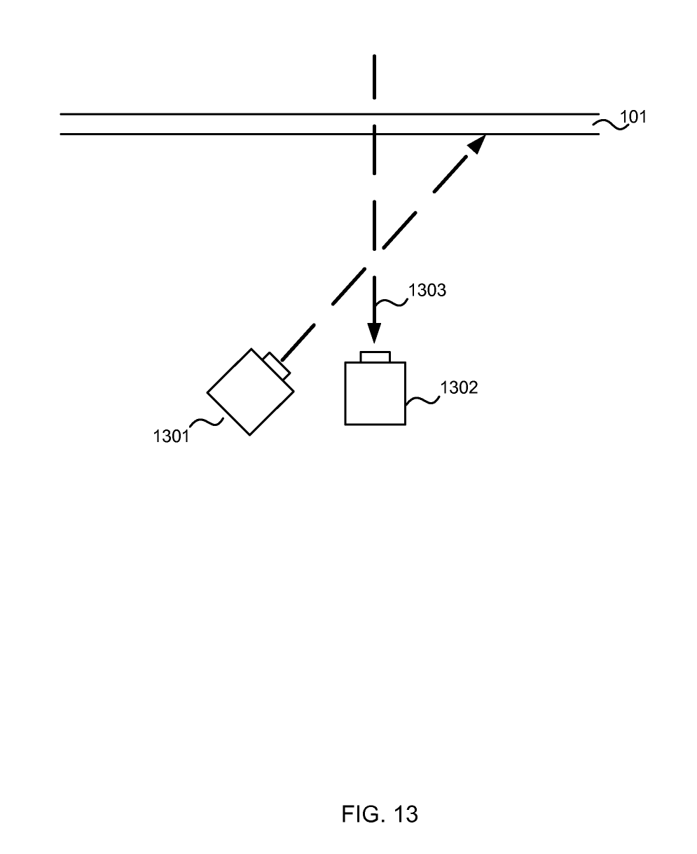

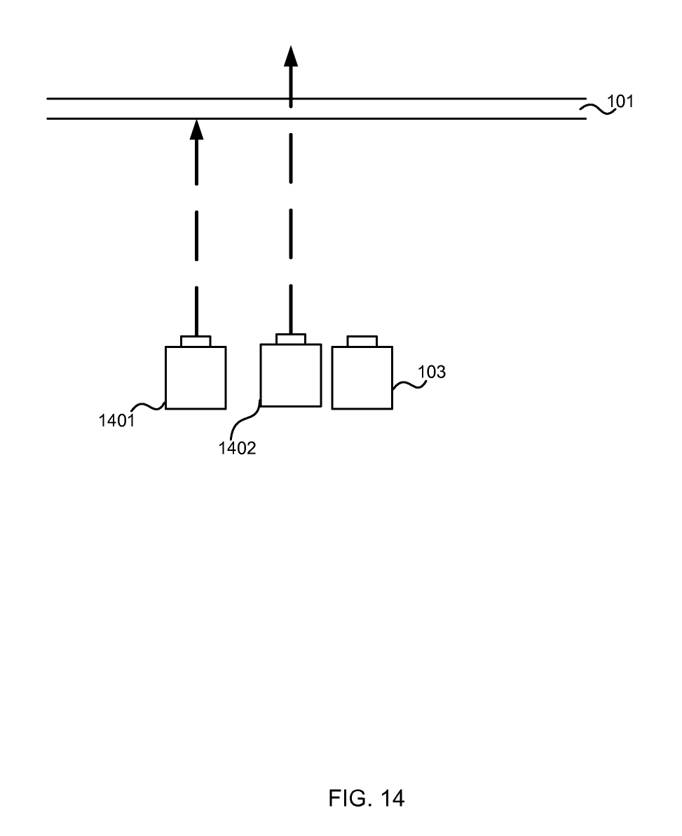

In other examples, the surface may not be switched between a diffuse and a transparent state but may have a diffuse and a transparent mode of operation dependent on the nature of the light incident upon the surface. For example, the surface may act as a diffuser for one orientation of polarized light and may be transparent to another polarization. In another example, the optical properties of the surface, and hence the mode of operation, may be dependent on the wavelength of the incident light (e.g. diffuse for visible light, transparent to IR) or the angle of incidence of the incident light. Examples are described below with reference to FIGS. 13 and 14.

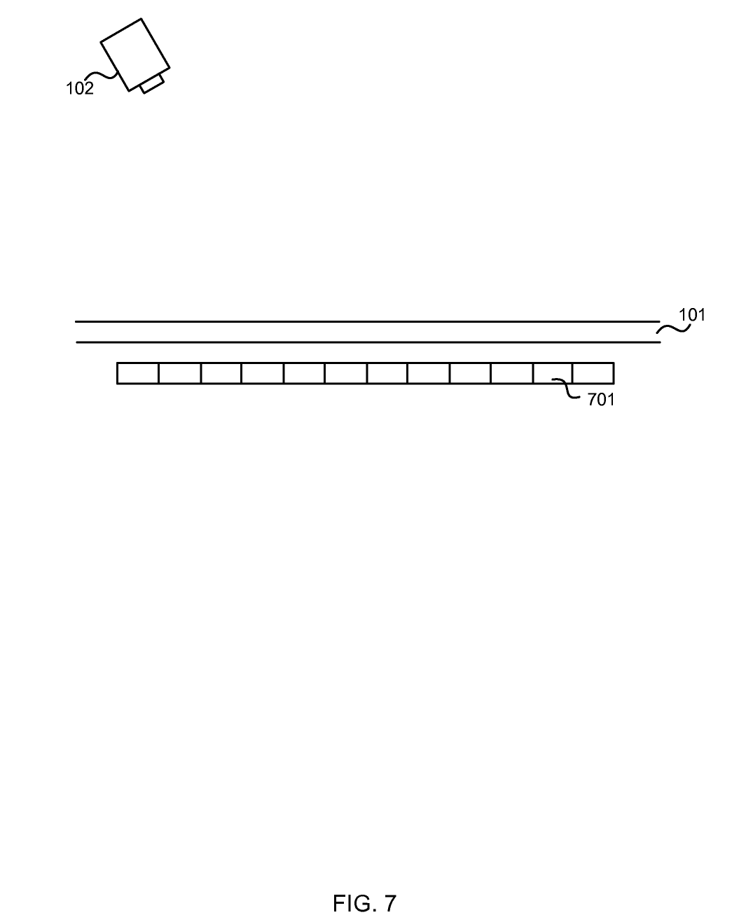

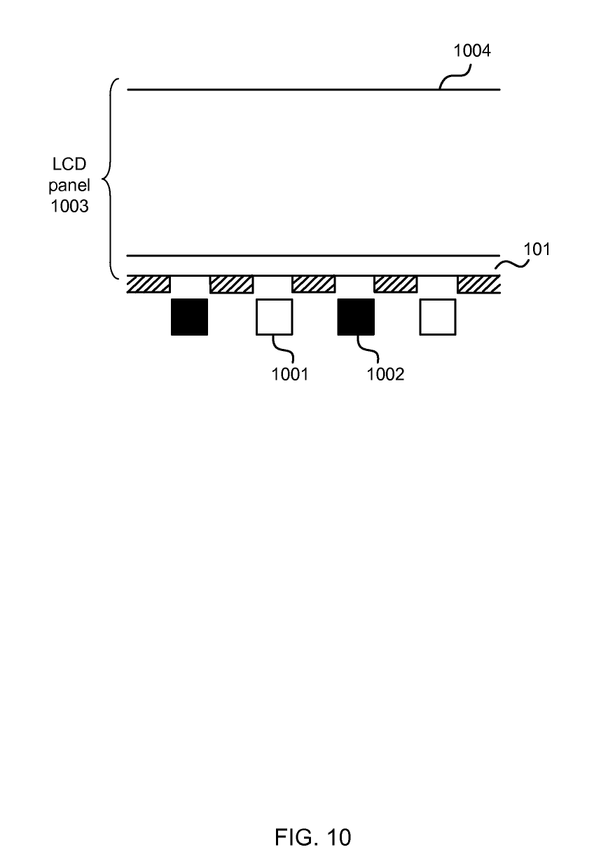

The display means in the surface computing device shown in FIG. 1 comprises a projector 102 which projects a digital image onto the rear of the surface 101 (i.e. the projector is on the opposite side of the surface to the viewer). This provides just one example of a suitable display means and other examples include a front projector (i.e. a projector on the same side of the surface as the viewer which projects onto the front of the surface) as shown in FIG. 7 or a liquid crystal display (LCD) as shown in FIG. 10. The projector 102 may be any type of projector, such as an LCD, liquid crystal on silicon (LCOS), Digital Light Processing™ (DLP) or laser projector. The projector may be fixed or steerable. The surface computing device may comprise more than one projector, as described in more detail below. In another example, a stereo projector may be used. Where the surface computing device comprises more than one projector (or more than one display means), the projectors may be of the same or different types. For example, a surface computing device may comprise projectors with different focal lengths, different operating wavelengths, different resolutions, different pointing directions etc.

The projector 102 may project an image irrespective of whether the surface is diffuse or transparent or alternatively, the operation of projector may be synchronized with the switching of the surface such that an image is only projected when the surface is in one of its state (e.g. when it is in its diffuse state). Where the projector is capable of being switched at the same speed as the surface, the projector may be switched directly in synchronization with the surface. In other examples, however, a switchable shutter (or mirror or filter) 104 may be placed in front of the projector and the shutter switched in synchronization with the surface. An example of a switchable shutter is a ferroelectric LCD shutter.

Any light source within the surface computing device, such as projector 102, any other display means or another light source, may be used for one or more of the following, when the surface is transparent:
Illumination of objects (e.g. to enable document imaging)
Depth determination, e.g. by projecting a structured light pattern onto an object
Data transmission, e.g. using IrDA
   Where the light source is also the display means, this may be in addition to projecting a digital image on the surface (e.g. as in FIG. 1). Alternatively multiple light sources may be provided within the surface computing device, with different light sources being used for different purposes. Further examples are described below.

The image capture device 103 may comprise a still or video camera and the images captured may be used for detection of objects in proximity to the surface computing device, for touch detection and/or for detection of objects at a distance from the surface computing device. The image capture device 103 may further comprise a filter 105 which may be wavelength and/or polarization selective. Whilst images are described above as being captured in ‘image capture mode’ (block 204) when the surface 101 is in its transparent state, images may also be captured, by this or another image capture device, when the surface is in its diffuse state (e.g. in parallel to block 202). The surface computing device may comprise one or more image capture devices and further examples are described below.

The capture of images may be synchronized with the switching of the surface. Where the image capture device 103 can be switched sufficiently rapidly, the image capture device may be switched directly. Alternatively, a switchable shutter 106, such as a ferroelectric LCD shutter, may be placed in front of the image capture device 103 and the shutter may be switched in synchronization with the surface.

Image capture devices (or other optical sensors) within the surface computing device, such as image capture device 103, may also be used for one or more of the following, when the surface is transparent:
Object imaging, e.g. document scanning, fingerprint detection etc
High resolution imaging
Gesture recognition
Depth determination, e.g. by imaging a structured light pattern projected onto an object
Identification of users
Receiving data e.g. using IrDA
   This may be in addition to use of the image capture device in touch detection, which is described in detail below. Alternatively other sensors may be used for touch detection. Further examples are also described below.

Touch detection may be performed through analysis of images captured in either or both of the modes of operation. These images may have been captured using image capture device 103 and/or another image capture device. In other embodiments, touch sensing may be implemented using other techniques, such as capacitive, inductive or resistive sensing. A number of example arrangements for touch sensing using optical sensors are described below.

The term ‘touch detection’ is used to refer to detection of objects in contact with the computing device. The objects detected may be inanimate objects or may be part of a user's body (e.g. hands or fingers).

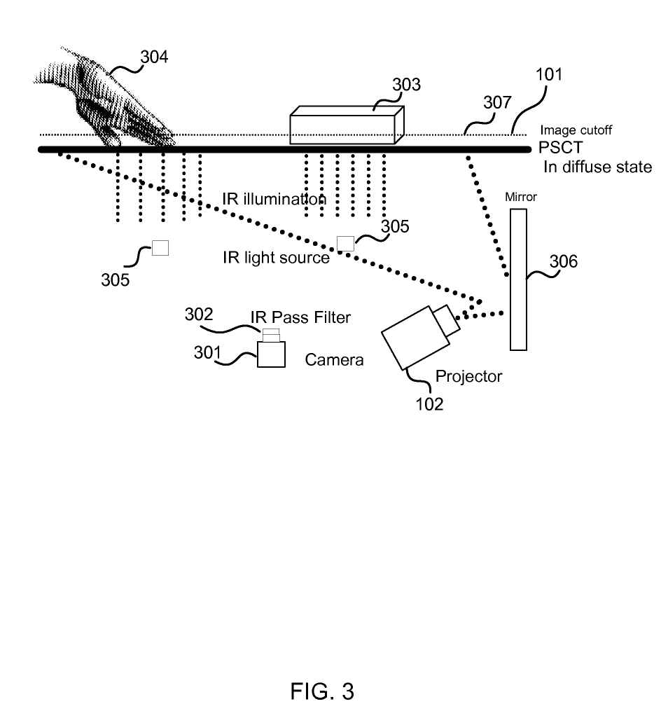

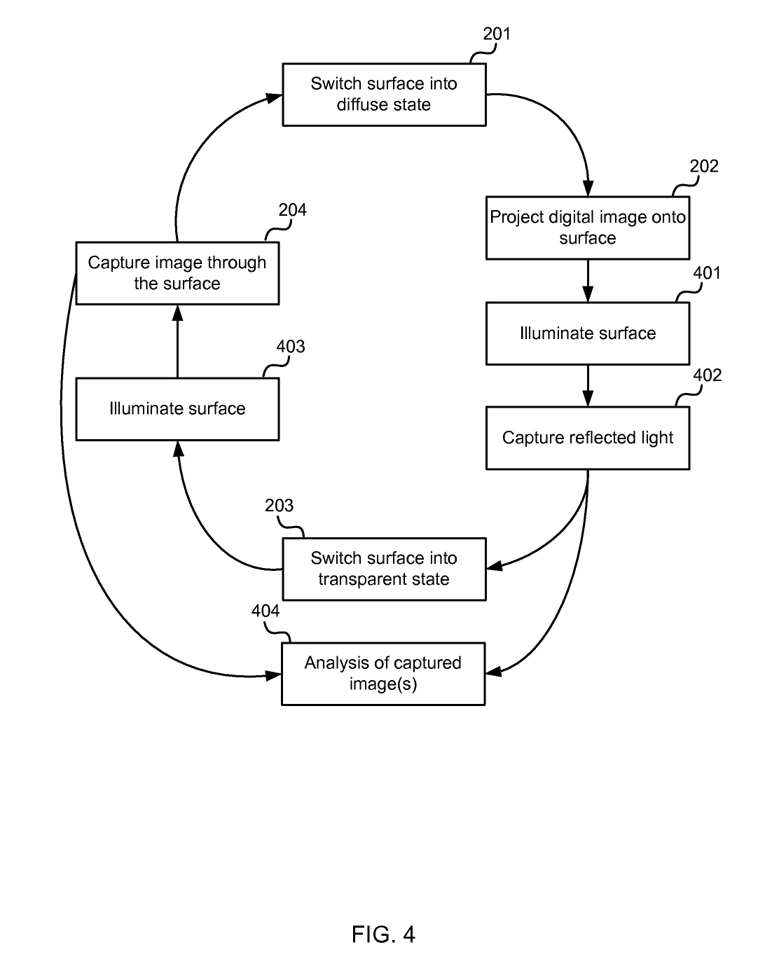

FIG. 3 shows a schematic diagram of another surface computing device and FIG. 4 shows another example method of operation of a surface computing device. The surface computing device comprises a surface 101, a projector 102, a camera 301 and an IR pass-band filter 302. Touch detection may be performed through detection of shadows cast by an object 303, 304 coming into contact with the surface 101 (known as ‘shadow mode’) and/or through detection of the light reflected back by the objects (known as ‘reflective mode’). In reflective mode, a light source (or illuminant) is required to illuminate objects which are brought into contact with the screen. Fingers are 20% reflective to IR and so IR will reflect back from a user's fingers and be detected, as will IR based markers or silhouettes of IR reflective objects. For the purposes of explanation only, reflective mode is described and FIG. 3 shows a number of IR light sources 305 (although other wavelengths may alternatively be used). It will be appreciated that other examples may use shadow mode and therefore may not include the IR light sources 305. The light sources 305 may comprise high power IR light emitting diodes (LEDs). The surface computing device shown in FIG. 3 also comprises a mirror 306 to reflect the light projected by the projector 102. The mirror makes the device more compact by folding the optical train, but other examples may not include the mirror.

Touch detection in reflective mode may be performed by illuminating the surface 101 (blocks 401, 403), capturing the reflected light (blocks 402, 204) and analyzing the captured images (block 404). As described above, touch detection may be based on images captured in either or both the projection (diffuse) mode and the image capture (transparent) mode (with FIG. 4 showing both). Light passing through the surface 101 in its diffuse state is attenuated more than light passing through the surface 101 in its transparent state. The camera 103 captures greyscale IR depth images and the increased attenuation results in a sharp cut-off in the reflected light when the surface is diffuse (as indicated by dotted line 307) with objects only appearing in captured images once they are close to the surface and with the intensity of the reflected light increasing as they move closer to the surface. When the surface is transparent, reflected light from objects which are much further from the surface can be detected and the IR camera captures a more detailed depth image with less sharp cut-offs. As a result of the difference in attenuation, different images may be captured in each of the two modes even where the objects in proximity to the surface have not changed and by using both images in the analysis (block 404) additional information about the objects can be obtained. This additional information may, for example, enable the reflectivity of an object (e.g. to IR) to be calibrated. In such an example, an image captured through the screen in its transparent mode may detect skin tone or another object (or object type) for which the reflectivity is known (e.g. skin has a reflectivity of 20% with IR).

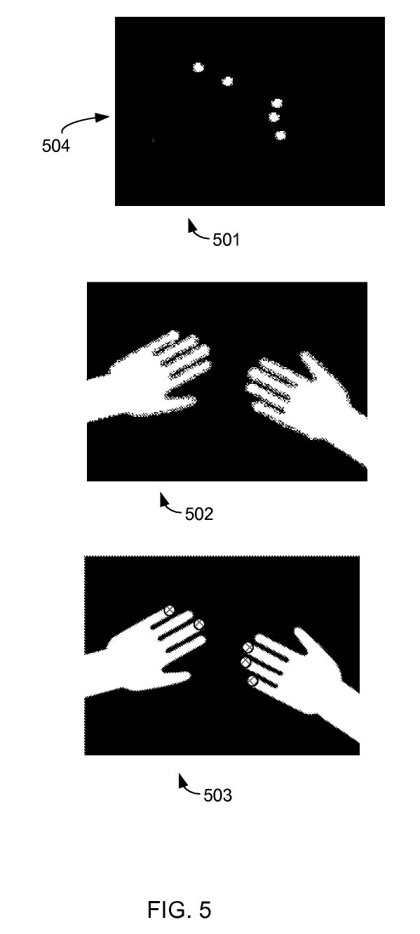

FIG. 5 shows two example binary representations of captured images 501, 502 and also shows the two representations overlaid 503. A binary representation may be generated (in the analysis, block 404) using an intensity threshold, with areas of the detected image having an intensity exceeding the threshold being shown in white and areas not exceeding the threshold being shown in black. The first example 501 is representative of an image captured when the surface was diffuse (in block 402) and the second example 502 is representative of an image captured when the surface was transparent (in block 204). As a result of the increased attenuation caused by the diffuse surface, (and the resultant cut-off 307), the first example 501 shows five white areas 504 which correspond to five fingertips in contact with the surface, whilst the second example 502 shows the position of two hands 505. By combining the data from these two examples 501, 502 as shown in example 503, additional information is obtained and in this particular example it is possible to determine that the five fingers in contact with the surface are from two different hands.

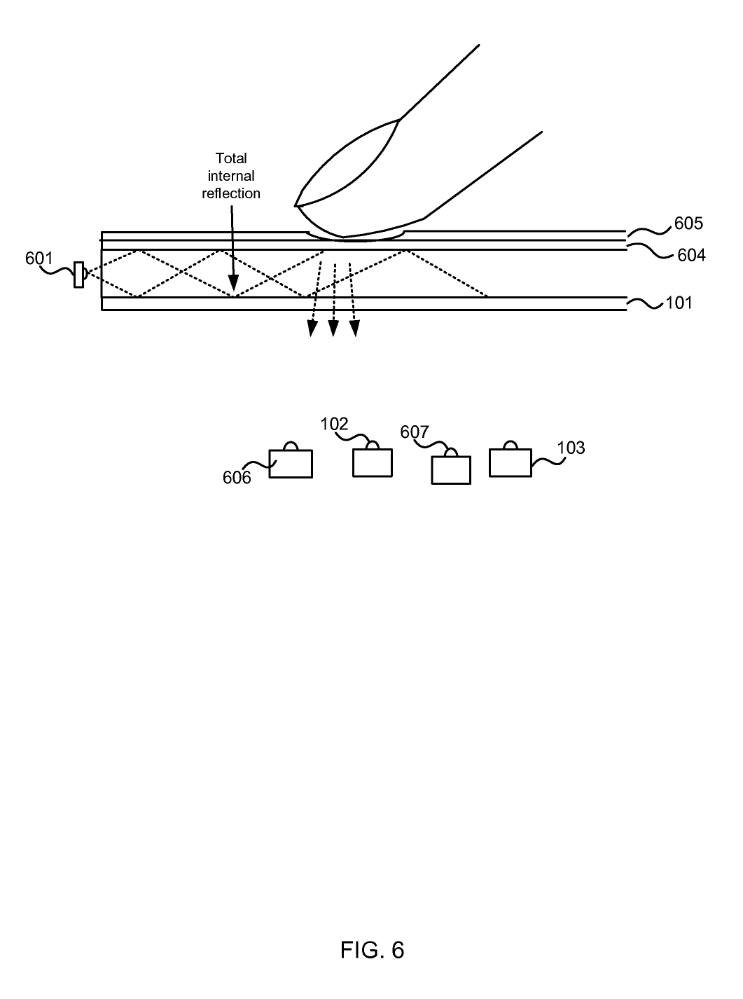

FIG. 6 shows a schematic diagram of another surface computing device which uses frustrated total internal reflection (FTIR) for touch detection. A light emitting diode (LED) 601 (or more than one LED) is used to shine light into an acrylic pane 602 and this light undergoes total internal reflection (TIR) within the acrylic pane 602. When a finger 603 is pressed against the top surface of the acrylic pane 602, it causes light to be scattered. The scattered light passes through the rear surface of the acrylic pane and can be detected by a camera 103 located behind the acrylic pane 602. The switchable surface 101 may be located behind the acrylic pane 602 and a projector 102 may be used to project an image onto the rear of the switchable surface 101 in its diffuse state. The surface computing device may further comprise a thin flexible layer 604, such as a layer of silicone rubber, on top of the acrylic pane 602 to assist in frustrating the TIR.

In FIG. 6 the TIR is shown within the acrylic pane 602. This is by way of example only and the TIR may occur in layers made of different materials. In another example, the TIR may occur within the switchable surface itself when in a transparent state or within a a layer within the switchable surface. In many examples, the switchable surface may comprise a liquid crystal or other material between two transparent sheets which may be glass, acrylic or other material. In such an example, the TIR may be within one of the transparent sheets within the switchable surface.

In order to reduce or eliminate the effect of ambient IR radiation on the touch detection, an IR filter 605 may be included above the plane in which the TIR occurs. This filter 605 may block all IR wavelengths or in another example, a notch filter may be used to block only the wavelengths which are actually used for TIR. This allows IR to be used for imaging through the surface if required (as described in more detail below).

The use of FTIR, as shown in FIG. 6, for touch detection may be combined with imaging through the switchable surface (in its clear state) in order to detect objects which are close to the surface but not in contact with it. The imaging may use the same camera 103 as used to detect touch events or alternatively another imaging device 606 may be provided. In addition, or instead, light may be projected through the surface in its clear state. These aspects are described in more detail below. The device may also comprise element 607 which is described below.

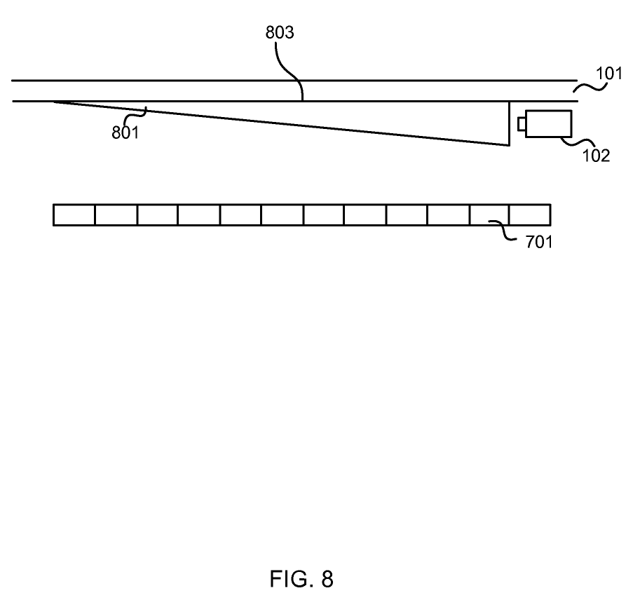

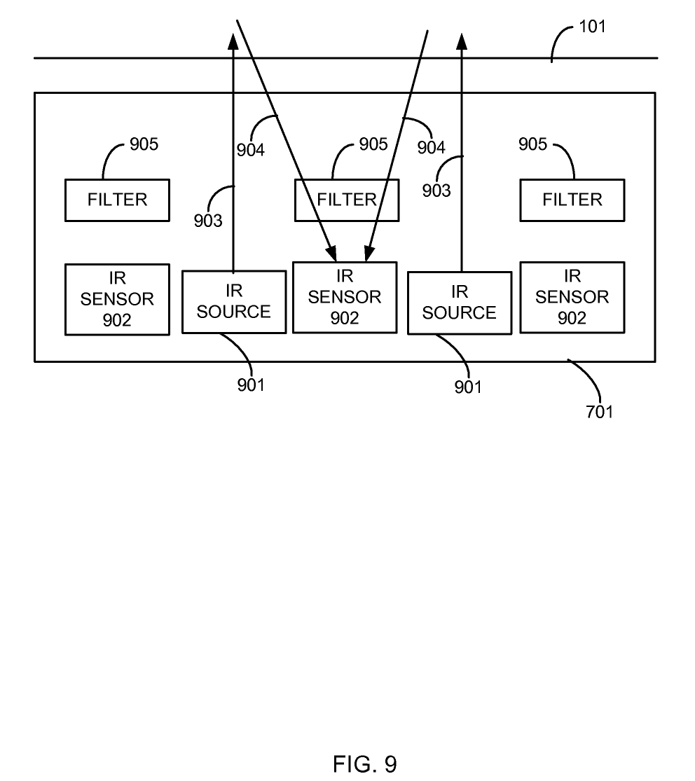

FIGS. 7 and 8 show schematic diagrams of two example surface computing devices which use an array 701 of IR sources and IR sensors for touch detection. FIG. 9 shows a portion of the array 701 in more detail. The IR sources 901 in the array emit IR 903 which passes through the switchable surface 101. Objects which are on or close to the switchable surface 101 reflect the IR and the reflected IR 904 is detected by one or more IR sensors 902. Filters 905 may be located above each IR sensor 902 to filter out wavelengths which are not used for sensing (e.g. to filter out visible light). As described above, the attenuation as the IR passes through the surface is dependent on whether it is in diffuse or transparent state and this affects the detection range of the IR sensors 902.

The surface computing device shown in FIG. 7 uses front projection, whilst the surface computing device shown in FIG. 8 uses wedge shaped optics 801, such as the Wedge® developed by CamFPD, to produce a more compact device. In FIG. 7 the projector 102 projects the digital image onto the front of the switchable surface 102 and this is visible to a viewer when the surface is in its diffuse state. The projector 102 may project the image continuously or the projection may be synchronized with the switching of the surface (as described above). In FIG. 8 the wedge shaped optics spread the projected image, input at one end 802 and the projected image emerges from the viewing face 803 at 90° to the input light. The optics converts the angle of incidence of the edge-injected light to a distance along the viewing face. In this arrangement, the image is projected onto the rear of the switchable surface.

FIG. 10 shows another example of a surface computing device which uses IR sources 1001 and sensors 1002 for touch detection. The surface computing device further comprises an LCD panel 1003 which includes the switchable surface 101 in place of a fixed diffuser layer. The LCD panel 1003 provides the display means (as described above). As in the computing devices shown in FIGS. 1, 3, and 7-9 when the switchable surface 101 is in its diffuse state, the IR sensors 1002 detect only objects which are very close to the touch surface 1004 because of the attenuation of the diffusing surface, and when the switchable surface 101 is in its transparent state, objects which are at a greater distance from the touch surface 1004 can be detected. In the devices shown in FIGS. FIGS. 1, 3, and 7-9 the touch surface is the front surface of the switchable surface 101, whilst in the device shown in FIG. 10 (and also in the device shown in FIG. 6), the touch surface 1004 is in front of the switchable surface 101 (i.e. closer to the viewer than the switchable surface).

Where touch detection uses detection of light (e.g. IR light) which is deflected by objects on or near the surface (e.g. using FTIR or reflective mode, as described above), the light source may be modulated to mitigate effects due to ambient IR or scattered IR from other sources. In such an example, the detected signal may be filtered to only consider components at the modulation frequency or may be filtered to remove a range of frequencies (e.g. frequencies below a threshold). Other filtering regimes may also be used.

In another example, stereo cameras placed above the switchable surface 101 may be used for touch detection. Use of stereo cameras for touch detection in a top-down approach is described in a paper by S. Izadi et al entitled “C-Slate: A Multi-Touch and Object Recognition System for Remote Collaboration using Horizontal Surfaces” and published in IEEE Conference on Horizontal Interactive Human-Computer Systems, Tabletop 2007. Stereo cameras may be used in a similar way in a bottom-up configuration, with the stereo cameras located below the switchable surface, and with the imaging being performed when the switchable surface is in its transparent state. As described above, the imaging may be synchronized with the switching of the surface (e.g. using a switchable shutter).

Optical sensors within a surface computing device may be used for imaging in addition to, or instead of, using them for touch detection (e.g. where touch detection is achieved using alternative technology). Furthermore, optical sensors, such as cameras, may be provided to provide visible and/or high resolution imaging. The imaging may be performed when the switchable surface 101 is in its transparent state. In some examples, imaging may also be performed when the surface is in its diffuse state and additional information may be obtained by combining the two captured images for an object.

When imaging objects through the surface, the imaging may be assisted by illuminating the object (as shown in FIG. 4). This illumination may be provided by projector 102 or by any other light source.

In an example, the surface computing device shown in FIG. 6 comprises a second imaging device 606 which may be used for imaging through the switchable surface when it is in its transparent state. The image capture may be synchronized with the switching of the switchable surface 101, e.g. by directly switching/triggering the image capture device or through use of a switchable shutter.

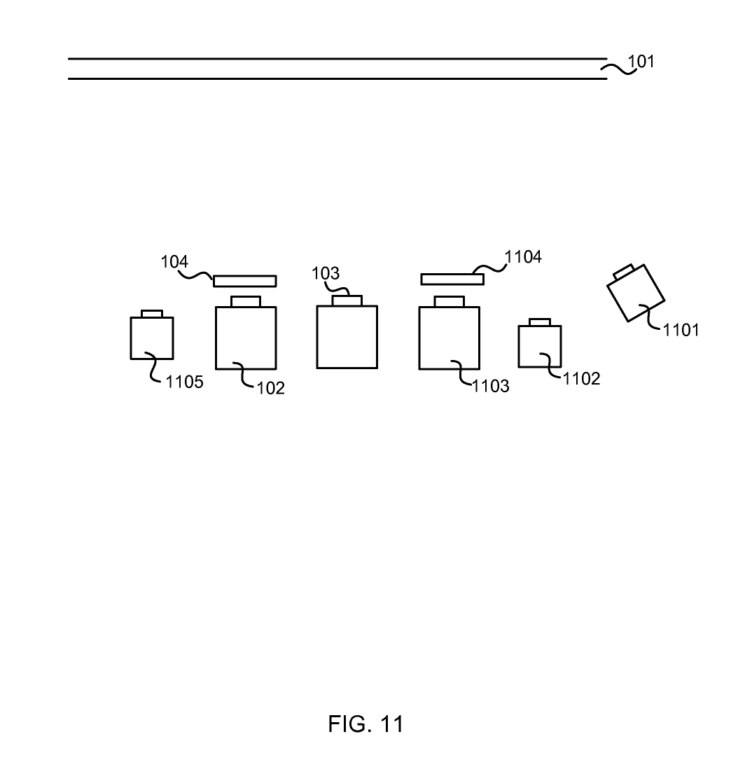

There are many different applications for imaging through the surface of a surface computing device and dependent upon the application, different image capture devices may be required. A surface computing device may comprise one or more image capture device and these image capture devices may be of the same or different types. FIGS. 6 and 11 show examples of surface computing devices which comprise more than one image capture device. Various examples are described below.

A high resolution image capture device which operates at visible wavelengths may be used to image or scan objects, such as documents placed on the surface computing device. The high resolution image capture may operate over all of the surface or over only a part of the surface. In an example, an image captured by an IR camera (e.g. camera 103 in combination with filter 105) or IR sensors (e.g. sensors 902, 1002) when the switchable surface is in its diffuse state may be used to determine the part of the image where high resolution image capture is required. For example, the IR image (captured through the diffuse surface) may detect the presence of an object (e.g. object 303) on the surface. The area of the object may then be identified for high resolution image capture using the same or a different image capture device when the switchable surface 101 is in its transparent state. As described above, a projector or other light source may be used to illuminate an object which is being imaged or scanned.

The images captured by an image capture device, (which may be a high resolution image capture device), may be subsequently processed to provide additional functionality, such as optical character recognition (OCR) or handwriting recognition.

In a further example, an image capture device, such as a video camera, may be used to recognize faces and/or object classes. In an example random forest based machine learning techniques that use appearance and shape clues may be used to detect the presence of an object of a particular class.

A video camera located behind the switchable surface 101 may be used to capture a video clip through the switchable surface in its transparent state. This may use IR, visible or other wavelength. Analysis of the captured video may enable user interaction with the surface computing device through gestures (e.g. hand gestures) at a distance from the surface. In another example, a sequence of still images may be used instead of a video clip. The data (i.e. the video or sequence of images) may also be analyzed to enable mapping of detected touch points to users. For example, touch points may be mapped to hands (e.g. using analysis of the video or the methods described above with reference to FIG. 5) and hands and arms may be mapped into pairs (e.g. based on their position or on their visual features such as the color/pattern of clothing) to enable identification of the number of users and which touch points correspond to actions of different users. Using similar techniques, hands may be tracked even if they temporarily disappear from view and then return. These techniques may be particularly applicable to surface computing devices which are able to be used by more than one user at the same time. Without the ability to map groups of touch points to a particular user, the touch points may be misinterpreted (e.g. mapped to the wrong user interaction) in a multi-user environment.

Imaging through the switchable surface in its diffuse state enables tracking of objects and recognition of coarse barcodes and other identifying marks. However, use of a switchable diffuser enables recognition of more detailed barcodes by imaging through the surface in its transparent state. This may enable unique identification of a wider range of objects (e.g. through use of more complex barcodes) and/or may enable the barcodes to be made smaller. In an example, the position of objects may be tracked, either using the touch detection technology (which may be optical or otherwise) or by imaging through the switchable surface (in either state) and periodically, a high resolution image may be captured to enable detection of any barcodes on the objects. The high resolution imaging device may operate in IR, UV or visible wavelengths.

A high resolution imaging device may also be used for fingerprint recognition. This may enable identification of users, grouping of touch events, user authentication etc. Depending on the application, it may not be necessary to perform full fingerprint detection and simplified analysis of particular features of a fingerprint may be used. An imaging device may also be used for other types of biometric identification, such as palm or face recognition.

In an example, color imaging may be performed using a black and white image capture device (e.g. a black and white camera) and by sequentially illuminating the object being imaged with red, green and blue light.

FIG. 11 shows a schematic diagram of a surface computing device which includes an off-axis image capture device 1101. An off-axis image capture device, which may for example comprise a still image or video camera, may be used to image objects and people that are around the perimeter of the display. This may enable capture of the faces of users. Face recognition may subsequently be used to identify users or to determine the number of users and/or what they are looking at on the surface (i.e. which part of the surface they are viewing). This may be used for gaze recognition, eye gaze tracking, authentication etc. In another example, it may enable the computing device to react to the positions of people around the surface (e.g. by changing the UI, by changing the speakers used for audio etc). The surface computing device shown in FIG. 11 also comprises a high resolution image capture device 1105.

The above description relates to imaging of an object directly through the surface. However, through use of mirrors located above the surface, other surfaces may be imaged. In an example, if a mirror is mounted above the surface computing device (e.g. on the ceiling or on a special mounting), both sides of a document placed on the surface may be imaged. The mirror used may be fixed (i.e. always a mirror) or may be switchable between a mirror state and a non-mirror state.

As described above, the whole surface may be switched or only a portion of the surface may be switched between modes. In an example, the location of an object may be detected, either through touch detection or by analysis of a captured image, and then the surface may be switched in the region of the object to open a transparent window through which imaging can occur, e.g. high resolution imaging, whilst the remainder of the surface stays diffuse to enable an image to be displayed. For example, where palm or fingerprint recognition is performed, the presence of a palm or fingers in contact with the surface may be detected using a touch detection method (e.g. as described above). Transparent windows may be opened in the switchable surface (which otherwise remains diffuse) in the areas where the palm/fingertips are located and imaging may be performed through these windows to enable palm/fingerprint recognition.

A surface computing device, such as any of those described above, may also capture depth information about objects that are not in contact with the surface. The example surface computing device shown in FIG. 11 comprises an element 1102 for capturing depth information (referred to herein as a ‘depth capturing element’). There are a number of different techniques which may be used to obtain this depth information and a number of examples are described below.

In a first example, the depth capturing element 1102 may comprise a stereo camera or pair of cameras. In another example, the element 1102 may comprise a 3D time of flight camera, for example as developed by 3DV Systems. The time of flight camera may use any suitable technology, including, but not limited to using acoustic, ultrasonic, radio or optical signals.

In another example, the depth capturing element 1102 may be an image capture device. A structured light pattern, such as a regular grid, may be projected through the surface 101 (in its transparent state), for example by projector 102 or by a second projector 1103, and the pattern as projected onto an object may be captured by an image capture device and analyzed. The structured light pattern may use visible or IR light. Where separate projectors are used for the projection of the image onto the diffuse surface (e.g. projector 102) and for projection of the structured light pattern (e.g. projector 1103), the devices may be switched directly or alternatively switchable shutters 104, 1104 may be placed in front of the projectors 102, 1103 and switched in synchronization with the switchable surface 101.

The surface computing device shown in FIG. 8, which comprises wedge shaped optics 801, such as the Wedge® developed by CamFPD, may use projector 102 to project a structured light pattern through the surface 101 in its transparent state.

The projected structured light pattern may be modulated so that the effects of ambient IR or scattered IR from other sources can be mitigated. In such an example, the captured image may be filtered to remove components away from the frequency of modulation, or another filtering scheme may be used.

The surface computing device shown in FIG. 6, which uses FTIR for touch detection, may also use IR for depth detection, either by using time of flight techniques or by projecting a structured light pattern using IR. Element 607 may comprise a time of flight device or a projector for projecting the structured light pattern. In order to separate out the touch detection and depth sensing, different wavelengths may be used. For example, the TIR may operate at 800 nm whilst the depth detection may operate at 900 nm. The filter 605 may comprise a notch filter which blocks 800 nm and therefore prevents ambient IR from interfering with the touch detection without affecting the depth sensing.

In addition to, or instead of, using a filter in the FTIR example, one or both of the IR sources may be modulated and where both are modulated, they may be modulated at different frequencies and the detected light (e.g. for touch detection and/or for depth detection) may be filtered to remove unwanted frequencies.

Depth detection may be performed by varying the diffusivity of the switchable surface 101 because the depth of field is inversely related to how the diffuse the surface is, i.e. the position of cut-off 307 (as shown in FIG. 3) relative to the surface 101 is dependent upon the diffusivity of the surface 101. Images may be captured or reflected light detected and the resultant data analyzed to determine where objects are visible or not and where objects come in and out of focus. In another example, greyscale images captured at varying degrees of diffusivity may be analyzed.

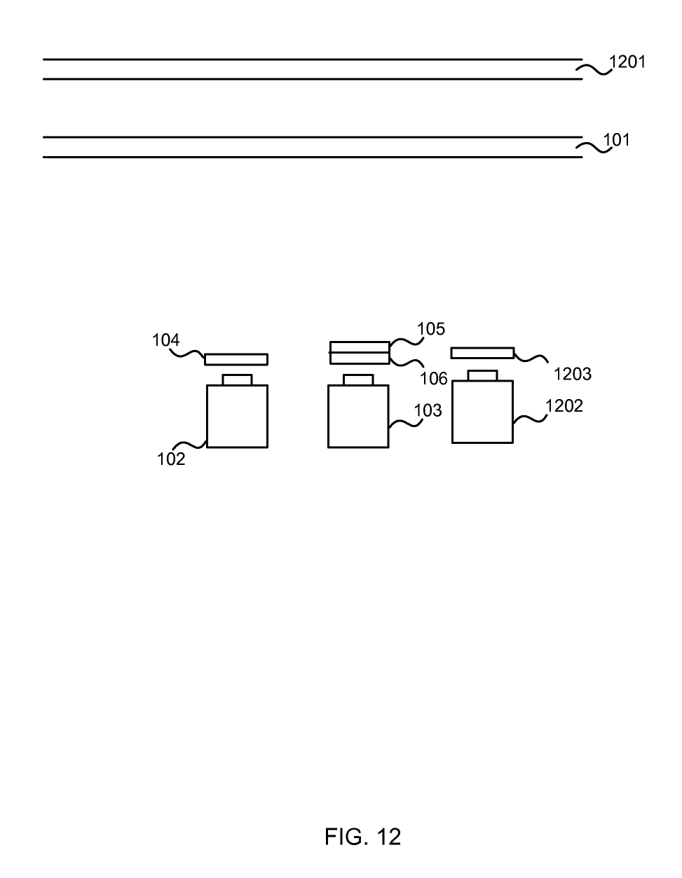

FIG. 12 shows a schematic diagram of another surface computing device. The device is similar to that shown in FIG. 1 (and described above) but comprises an additional surface 1201 and an additional projector 1202. As described above, the projector 1202 may be switched in synchronization with the switchable surface 101 or a switchable shutter 1203 may be used. The additional surface 1201 may comprise a second switchable surface or a semi-diffuse surface, such as a holographic rear projection screen. Where the additional surface 1201 is a switchable surface, the surface 1201 is switched in anti-phase to the first switchable surface 101 so that when the first surface 101 is transparent, the additional surface 1202 is diffuse, and vice versa. Such a surface computing device provides a two layer display and this can be used to provide an appearance of depth to a viewer (e.g. by projecting a character onto the additional surface 1201 and the background onto the first surface 101). In another example, less used windows/applications may be projected onto the rear surface with main windows/applications projected onto the front surface.

The idea may be further extended to provide additional surfaces, (e.g. two switchable and one semi-diffuse or three switchable surfaces) but if increasing numbers of switchable surfaces are used, the switching rate of the surface and the projector or shutter needs to increase if a viewer is not to see any flicker in the projected images. Whilst the use of multiple surfaces is described above with respect to rear projection, the techniques described may alternatively be implemented with front projection.

Many of the surface computing devices described above comprise IR sensors (e.g. sensors 902, 1002) or an IR camera (e.g. camera 301). In addition to detection of touch events and/or imaging, the IR sensors/camera may be arranged to receive data from a nearby object. Similarly, any IR sources (e.g. sources 305, 901, 1001) in the surface computing device may be arranged to transmit data to a nearby object. The communications may be uni-directional (in either direction) or bidirectional. The nearby object may be close to or in contact with the touch surface, or in other examples, the nearby object may be at a short distance from the touch screen (e.g. of the order of meters or tens of meters rather than kilometers).

The data may be transmitted or received by the surface computer when the switchable surface 101 is in its transparent state. The communication may use any suitable protocol, such as the standard TV remote control protocol or IrDA. The communication may be synchronized to the switching of the switchable surface 101 or short data packets may be used in order to minimize loss of data due to attenuation when the switchable surface 101 is in its diffuse state.

Any data received may be used, for example, to control the surface computing device, e.g. to provide a pointer or as a user input (e.g. for gaming applications).

As shown in FIG. 10, the switchable surface 101 may be used within an LCD panel 1003 instead of a fixed diffusing layer. The diffuser is needed in an LCD panel to prevent the image from floating and to remove any non-linearities in the backlighting system (not shown in FIG. 10). Where proximity sensors 1002 are located behind the LCD panel, as in FIG. 10, the ability to switch out the diffusing layer (i.e. by switching the switchable layer into its clear state) increases the range of the proximity sensors. In an example, the range may be extended by an order of magnitude (e.g. from around 15 mm to around 15 cm).

The ability to switch the layer between a diffuse state and a transparent state may have other applications such as providing visual effects (e.g. by enabling floating text and a fixed image). In another example, a monochrome LCD may be used with red, green and blue LEDs located behind the switchable surface layer. The switchable layer, in its diffuse state, may be used to spread the colors across the screen (e.g. where there may be well spread LEDs of each color) as they are illuminated sequentially to provide a color display.

Although the examples described above show an electrically switchable layer 101, in other examples the surface may have a diffuse and a transparent mode of operation dependent upon the nature of the light which is incident upon it (as described above). FIG. 13 shows a schematic diagram of an example surface computing device comprising a surface 101 where the mode of operation is dependent on the angle of incidence of the light. The surface computing device comprises a projector 1301 which is angled with respect to the surface to enable projection of an image on the rear of the surface 101 (i.e. the surface operates in its diffuse mode). The computing device also comprises an image capture device 1302 which is arranged so that it captures light which passes through the screen (as indicated by arrow 1303). FIG. 14 shows a schematic diagram of an example surface computing device comprising a surface 101 where the mode of operation is dependent on the wavelength/polarization light.

The switchable nature of the surface 101 may also enable imaging through the surface from the outside into the device. In an example, where a device comprising an image capture device (such as a mobile telephone comprising a camera) is placed onto the surface, the image capture device may image through the surface in its transparent state. In a multi-surface example, such as shown in FIG. 12, if a device comprising an image capture device is placed on the top surface 1201, it may image surface 1201 when that surface is in its diffuse state and image surface 101 when the top surface is in its transparent state and the lower surface is in its diffuse state. Any image captured of the upper surface will be out of focus and whilst an image captured of the lower surface may be in focus (depending on the separation of the two surfaces and the focusing mechanism of the device). One application for this is the unique identification of devices placed on a surface computing device and this is described in more detail below.

When a device is placed on the surface of a surface computing device, the surface computing device displays an optical indicator, such as a light pattern on the lower of the two surfaces 101. The surface computing device then runs a discovery protocol to identify wireless devices within range and sends messages to each identified device to cause them to use any light sensor to detect a signal. In an example the light sensor is a camera and the detected signal is an image captured by the camera. Each device then sends data identifying what was detected back to the surface computing device (e.g. the captured image or data representative of the captured image). By analyzing this data, the surface computing device can determine which other device detected the indicator that it displayed and therefore determine if the particular device is the device which is on its surface. This is repeated until the device on the surface is uniquely identified and then pairing, synchronization or any other interaction can occur over the wireless link between the identified device and the surface computing device. By using the lower surface to display the optical indicator, it is possible to use detailed patterns/icons because the light sensor, such as a camera, is likely to be able to focus on this lower surface.

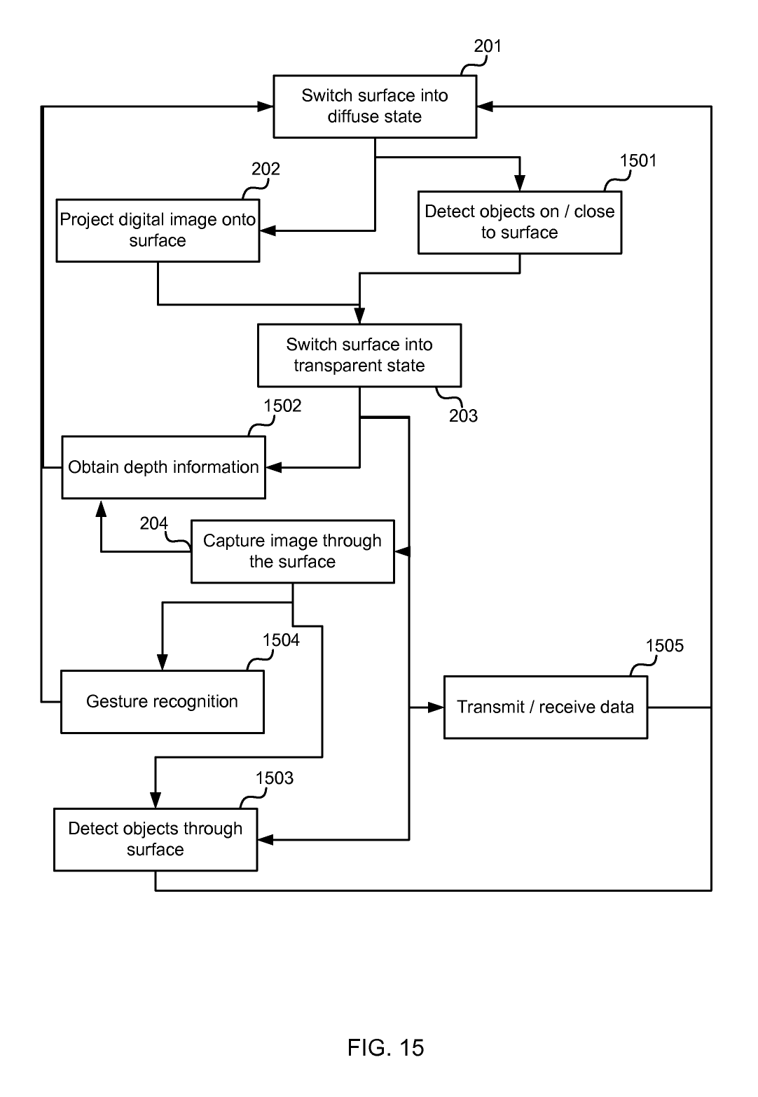

FIG. 15 is a flow diagram showing an example method of operation of a surface computing device, such as any of the devices described herein and shown in FIGS. 1, 3, 6-14 and 16. With the surface in its diffuse state (from block 201), a digital image is projected onto the surface (block 202). With the surface in its diffuse state, detection of objects on or close to the surface may also be performed (block 1501). This detection may comprise illuminating the surface (as in block 401 of FIG. 4) and capturing the reflected light (as in block 402 of FIG. 4) or alternative methods may be used.

With the surface in its transparent state (as switched in block 203), an image is captured through the surface (block 204). This image capture (in block 204) may include illumination of the surface (e.g. as shown in block 403 of FIG. 4). The captured image (from block 204) may be used in obtaining depth information (block 1502) and/or detecting objects through the surface (block 1503) or alternatively, depth information may be obtained (block 1502) or objects detected (block 1503) without using a captured image (from block 204). The captured image (from block 204) may be used for gesture recognition (block 1504). Data may be transmitted and/or received (block 1505) whilst the surface is in its transparent state.

The process may be repeated, with the surface (or part thereof) being switched between diffuse and transparent states at any rate. In some examples, the surface may be switched at rates which exceed the threshold for flicker perception. In other examples, where image capture only occurs periodically, the surface may be maintained in its diffuse state until image capture is required and then the surface may be switched to its transparent state.

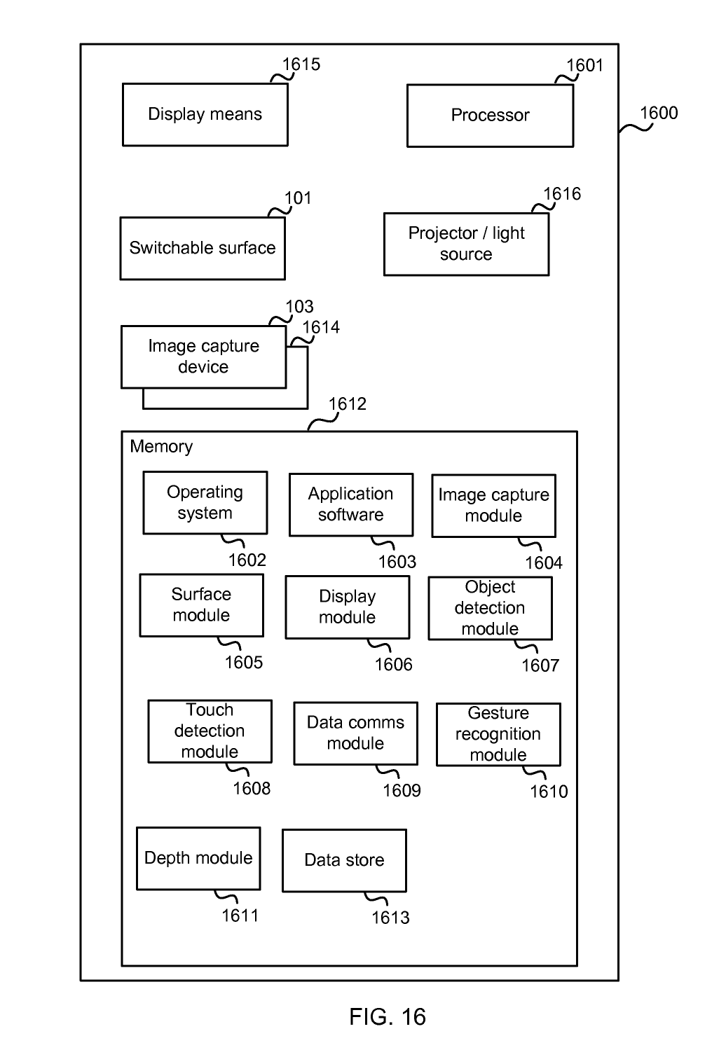

FIG. 16 illustrates various components of an exemplary surface computing-based device 1600 which may be implemented as any form of a computing and/or electronic device, and in which embodiments of the methods described herein (e.g. as shown in FIGS. 2, 4 and 15) may be implemented.

Computing-based device 1600 comprises one or more processors 1601 which may be microprocessors, controllers or any other suitable type of processors for processing computing executable instructions to control the operation of the device in order to operate as described above (e.g. as shown in FIG. 15). Platform software comprising an operating system 1602 or any other suitable platform software may be provided at the computing-based device to enable application software 1603-1611 to be executed on the device.

The application software may comprise one or more of:
An image capture module 1604 arranged to control one or more image capture devices 103, 1614;
A surface module 1605 arranged to cause the switchable surface 101 to switch between transparent and diffuse states;
A display module 1606 arranged to control the display means 1615;
An object detection module 1607 arranged to detect objects in proximity to the surface;
A touch detection module 1608 arranged to detect touch events (e.g. where different technologies are used for object detection and touch detection);
A data transmission/reception module 1609 arranged to receive/transmit data (as described above);
A gesture recognition module 1610 arranged to receive data from the image capture module 1604 and analyze the data to recognize gestures; and
A depth module 1611 arranged to obtain depth information for objects in proximity to the surface, e.g. by analyzing data received from the image capture module 1604.
   Each module is arranged to cause the switchable surface computer to operate as described in any one or more of the examples above.

The computer executable instructions, such as the operating system 1602 and application software 1603-1611, may be provided using any computer-readable media, such as memory 1612. The memory is of any suitable type such as random access memory (RAM), a disk storage device of any type such as a magnetic or optical storage device, a hard disk drive, or a CD, DVD or other disc drive. Flash memory, EPROM or EEPROM may also be used. The memory may also comprise a data store 1613 which may be used to store captured images, captured depth data etc.

The computing-based device 1600 also comprises a switchable surface 101, a display means 1615 and an image capture device 103. The device may further comprise one or more additional image capture devices 1614 and/or a projector or other light source 1616.

The computing-based device 1600 may further comprise one or more inputs (e.g. of any suitable type for receiving media content, Internet Protocol (IP) input etc), a communication interface and one or more outputs such as an audio output.

FIGS. 1, 3, 6-14 and 16 above show various different examples of surface computing devices. Aspects of any of these examples may be combined with aspects of other examples. For example, FTIR (as shown in FIG. 6) may be used in combination with front projection (as shown in FIG.7) or use of a Wedge® (as shown in FIG. 8). In another example, use of off-axis imaging (as shown in FIG. 11) may be used in combination with FTIR (as shown in FIG. 6) with touch sensing using IR (as shown in FIG. 3). In a further example, a mirror (as shown in FIG. 3) may be used to fold the optical train in any of the other examples. Other combinations not described are also possible within the spirit and scope of the invention.

Whilst the description above refers to the surface computing device being orientated such that the surface is horizontal (with other elements being described as above or below that surface), the surface computing device may be orientated in any manner. For example, the computing device may be wall mounted such that the switchable surface is vertical.

There are many different applications for the surface computing devices described herein. In an example, the surface computing device may be used in the home or in a work environment, and/or may be used for gaming. Further examples include use within (or as) an automated teller machine (ATM), where the imaging through the surface may be used to image the card and/or to use biometric techniques to authenticate the user of the ATM. In another example, the surface computing device may be used to provide hidden close circuit television (CCTV), for example in places of high security, such as airports or banks. A user may read information displayed on the surface (e.g. flight information at an airport) and may interact with the surface using the touch sensing capabilities, whilst at the same time, images can be captured through the surface when it is in its transparent mode.

Although the present examples are described and illustrated herein as being implemented in a surface computing system, the system described is provided as an example and not a limitation. As those skilled in the art will appreciate, the present examples are suitable for application in a variety of different types of computing systems.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A surface computing device comprising:
a surface layer having at least two modes of operation, wherein in a first mode of operation the surface layer is substantially diffusing and in a second mode of operation, the surface layer is substantially transparent;
a display means; and
an image capture device arranged to capture an image through the surface layer in the second mode of operation.

2. A surface computing device according to claim 1, wherein the surface layer is switched between the at least two modes of operation at a rate which exceeds a threshold for flicker perception.

3. A surface computing device according to claim 1, wherein the display means comprises one of a projector and a LCD panel.

4. A surface computing device according to claim 1, further comprising:
a light source arranged to project light through the surface layer in the second mode of operation.

5. A surface computing device according to claim 4, wherein the light comprises a light pattern.

6. A surface computing device according to claim 1, further comprising object sensing apparatus.

7. A surface computing device according to claim 1, further comprising:
a light source arranged to illuminate the surface layer; and
a light sensor arranged to detect emitted by the light source and deflected by an object in proximity to the surface layer.

8. A surface computing device according to claim 1, wherein the image capture device comprises a high-resolution image capture device.

9. A surface computing device according to claim 1, further comprising a second surface layer.

10. A surface computing device according to claim 1, further comprising:
a processor;
memory arranged to store executable instructions to cause the processor to:
control switching of the surface layer between modes; and
synchronise the switching of the surface layer and the display means.

11. A method of operating a surface computing device comprising:
switching a surface layer between a substantially diffuse and a substantially transparent mode of operation;
in the substantially diffuse mode of operation, displaying a digital image; and
in the substantially transparent mode of operation, capturing an image through the surface layer.

12. A method according to claim 11, wherein displaying a digital image comprises projecting a digital image onto the surface layer.

13. A method according to claim 11, further comprising:
in the substantially diffuse mode of operation, detecting objects in contact with the surface layer.

14. A method according to claim 11, further comprising:
in the substantially transparent mode of operation, projecting a light pattern through the surface.

15. A method according to claim 11, further comprising:
detecting objects through the surface layer.

16. A method according to claim 11, further comprising:
in the substantially transparent mode of operation, analyzing the image to identify a user gesture.

17. A method according to claim 11, further comprising:
in the substantially transparent mode of operation, performing one of transmission and reception of data through the surface layer.

18. A surface computing device comprising a layer which is electrically switched between a substantially transparent state and a substantially diffuse state; a projector arranged to project a digital image onto the layer in its substantially diffuse state; and an image capture device arranged to capture an image through the layer in its substantially transparent state.

19. A surface computing device according to claim 18, further comprising a projector arranged to project a light pattern through the layer in its substantially transparent state.

20. A surface computing device according to claim 18, further comprising touch detection apparatus.
